(19) United States
(12) Patent Application Publication
(10) Pub. No.: US 2020/0289986 A1
(43) Pub. Date: Sep. 17, 2020

(54) CONCURRENT DESALINATION AND BORON REMOVAL (CDBR) PROCESS

(71) Applicant: ISTANBUL TEKNIK UNIVERSITESI REKTORLUGU, Istanbul (TR)

(72) Inventors: William Bernard KRANTZ, Boulder, CO (US); Sadiye VELIOGLU, Istanbul (TR); Suer KURKLU, Istanbul (TR); Mehmet Goktug AHUNBAY, Istanbul (TR); Serife Birgul ERSOLMAZ, Istanbul (TR)

(73) Assignee: ISTANBUL TEKNIK UNIVERSITESI REKTORLUGU, Istanbul (TR)

(21) Appl. No.: 16/337,941

(22) PCT Filed: Oct. 19, 2016
(86) PCT No.: PCT/TR2016/050387

§ 371 Date: Mar. 29, 2019

(51) Int. Cl. B01D 61/02; B01D 61/08; C02F 1/44

(52) U.S. Cl. CPC B01D 61/022; B01D 61/08; C02F 2101/108; C02F 1/441; C02F 1/442

(57) ABSTRACT

A concurrent desalination and boron removal (CDBR) process and a system thereof are provided. The system includes: a plurality of single-stage reverse osmosis (SSRO) stages connected in series, and a countercurrent membrane cascade with recycle (CMCR). The process includes the following steps: introducing a retentate from one SSRO stage or a series of SSRO stages optimally as a feed to a CMCR; countercurrent a retentate flow and a permeate flow in the CMCR; permeate recycling to a retentate side in the CMCR; retentate self-recycling in at least one of membrane stages in the CMCR; introducing a permeate from the SSRO stage(s) as a feed to an LPMS; and blending permeate streams from the CMCR and LPMS to achieve concentrations in a water product.

### CROSS REFERENCE TO THE RELATED APPLICATIONS

This application is the national phase entry of International Application No. PCT/TR2016/050387, filed on Oct. 19, 2016, the entire contents of which are incorporated herein by reference.

### TECHNICAL FIELD

The present invention relates to a novel multistage membrane process technology that enables producing a potable water product from saline water feed at a high water recovery, reduced osmotic pressure differential and competitive net specific energy consumption (SECₙₑₜ) while simultaneously reducing the boron concentration to the level recommended for both human consumption and crop irrigation.

### BACKGROUND

There is a continuing need to improve the efficiency and reduce the cost of supplying potable water owing to the pressures of an expanding world population, changing demographics, and global climate change. Nearly 700 million people in the world lack access to safe drinking water. In January of 2015 the World Economic Forum announced that the water crisis is the number one global risk based on impact to society. Crop irrigation associated with the food sector of the global economy uses 70% of the world's freshwater. Additional sources need to be tapped to satisfy the increasing water demand for both human consumption and crop irrigation.

The oceans that contain 97% of the water on earth are a major resource. However, ocean water can contain as much as 50000 parts per million (ppm) of salt (sodium chloride) and other low molecular weight solutes that make it unfit for human consumption or irrigation without treatment. Reverse osmosis (RO) has emerged as a major technology for producing potable water from seawater as well as inland brackish water that has a salt content ranging from 500 ppm to 30000 ppm. RO uses a salt-rejecting membrane under high pressure in order to force water to permeate through the membrane while rejecting the salt and other solutes. Conventional RO technology requires a very high pressure, typically 50 bars or more, which contributes significantly to the cost of water desalination. Moreover, conventional RO technology has a limited potable water recovery, typically 50%, owing to the very high pressures required to achieve higher water recoveries. As a result, the specific energy consumption (SEC) for producing potable water from saline water is quite high. In order to reduce a salt concentration of 35000 ppm in seawater to 350 ppm in the product water, conventional single-stage reverse osmosis (SSRO) operating at a pressure of 55.5 bar and a water recovery of 50% using a membrane with a salt rejection of 0.990 requires a net SEC of 2.242 kWh/m3 (kilowatt hours of energy per cubic meter of product water). For this reason the cost of water obtained via desalination is more than twice the cost of water obtained from freshwater sources.

A concurrent problem is that typical seawater contains 10 ppm or more of boron. The World Health Organization (WHO) has recommended that the maximum boron concentration in water for human consumption should be below 2.4 ppm and for irrigation should be below 0.5 ppm, particularly for citrus and nut orchards. Boron is present in seawater as boric acid, which is only slightly larger than the clusters of hydrogen-bonded water molecules. Hence, conventional RO membranes have relatively low boron rejections, typically less than 90%, and therefore cannot reduce the boron concentration via conventional desalination technologies to a concentration of 0.5 ppm. Higher boron rejections are possible with current RO membranes if the pH (logarithm of the hydrogen ion concentration) of the feed solution to the membrane process is increased above the pK (logarithm of the dissociation constant) of 9.14 for the ionization of boric acid to borate ions, which when hydrated are sufficiently larger than the hydrogen-bonded water molecules to enable adequate rejection via commercial RO membranes. However, this process is expensive since it requires reducing the highly alkaline pH after the boron removal. Boron removal from seawater is usually done as a post-treatment process after desalination. However, this is also costly since huge volumes of water must be processed twice, one for desalination and again for boron removal. Concurrent desalination and boron removal (CDBR) is attractive but challenging owing to the poor rejections of commercially available RO membranes.

Prior art patents related with the present invention are listed as below;
U.S. Provisional Patent Application No. 61/972,718 describes the energy-efficient reverse osmosis (EERO) process. Although the novel CDBR invention described here incorporates the energy-saving features of the EERO process, it is substantively different in that it employs an additional low pressure membrane stage (LPMS) to produce a permeate stream with a very low boron concentration that is blended with the permeate stream from the CMCR to achieve the desired boron concentration.
U.S. Pat. No. 9,108,865 describes a treatment method for boron-containing water that involves two processes in series: the first process uses evaporation to concentrate the boron; the second uses different inorganic hydroxides to further reduce the boron by adsorption. This process is mainly used for reducing very high aqueous boron concentrations (typically 1×10⁶ ppm) to a lower concentration (typically ˜1×10⁵ ppm). Whereas the boron removal is 85.7% for a feed concentration of 1×10⁶ ppm, it decreases to 68.3% for a feed concentration of 2.5×10⁵ ppm. Hence, this process would have a very low boron removal for typical seawater whose boron concentration is 10 ppm and hence could not achieve the target product concentration of 0.5 ppm.
U.S. Pat. No. 9,090,491 involves first reducing the boron concentration in seawater to less than 0.2 ppm by increasing the pH between 8.5 and 10 using alkaline in an NF membrane stage. The permeate product from this stage is blended with that from a high pressure (82 bar) RO stage that both desalinates the water and reduces the boron concentration to less than 1 ppm such that the boron in the blended permeate product has a concentration less than 0.2 ppm. This process involves series rather than concurrent desalination and boron removal. It requires adding alkaline chemicals to increase the pH that must be lowered back to near neutral pH in the final product. Moreover, the RO part of this two-stage process requires a very high pressure. The CDBR invention concurrently removes salt and boron without the addition of any chemicals and operates at considerably lower pressure.
U.S. Pat. Nos. 9,073,763 and 8,617,398 involve a series of two stages, a high pressure RO stage and an ion-exchange stage. Alkaline chemicals are added to the feed to increase its pH to as high as 11 to enhance the boron rejection of the membrane in the RO stage. Additional boron removal is achieved via an ion-exchange stage. In contrast to the CDBR invention described here, this process does not achieve concurrent desalination and boron removal, requires the addition and subsequent removal of chemicals to change the pH, and requires high pressure operation in the RO stage. Moreover, this process requires regeneration of the ion-exchange resin.
U.S. Pat. No. 8,999,171 uses ultrafiltration, air stripping, nanofiltration, and chemical addition to obtain a pH between 9.5 and 10 as pretreatment for a saline water feed to low pressure RO followed by electrodialysis to achieve 0.5 ppm boron in the product water. This process is far more complex that the CDBR invention. In particular, it does not involve concurrent desalination and boron removal and also requires adjusting the pH.
U.S. Pat. No. 8,357,300 describes series staging of RO and ultrafiltration (UF) in which complexation of the boron with micelles allows adequate rejection to achieve very low boron concentrations. In contrast to the CDBR invention described here, this process does not involve concurrent desalination and boron removal and also requires higher pressure operation owing to the RO stage. It also requires regeneration of the micelles.
U.S. Pat. No. 7,618,538 describes an RO membrane process that uses one or more metals along with at least one anti-scaling dispersing agent for desalination and boron removal from seawater. It uses an alkalinizing agent to increase the pH to between 8 and 9.5. This process requires readjusting the pH back to near neutral levels in order to obtain satisfactory product water. Since it involves conventional RO, it necessarily will operate at higher pressures. The CDBR invention does not require any addition of chemicals or pH adjustment and can operate at substantially lower pressures than conventional RO.
U.S. Pat. No. 7,442,309 also uses RO for desalination and boron removal that is facilitated by chemical addition to increase the pH to as high as 9.5. The pH must be reduced after the boron removal to obtain a satisfactory product water. Since this process involves conventional RO, it necessarily will operate at higher pressures. The CDBR invention does not require any chemical addition for pH adjustment and can achieve desalination at substantially lower pressures than conventional reverse osmosis.
U.S. Pat. No. 7,368,058 describes a process involving RO and adsorption stages to achieve desalination and boron removal. It requires regeneration of the adsorbent. Since it involves conventional RO, it necessarily will operate at high pressures. The CDBR invention achieves concurrent desalination and boron removal at substantially lower pressure than conventional RO and does not require the use of an adsorbent.
U.S. Pat. No. 7,264,737 involves series staging of either two RO stages or an RO stage and an electrodialysis stage to achieve desalination and boron removal. Since it involves conventional RO, it necessarily must operate at high pressure. Series staging in this manner necessarily reduces the overall water recovery since the feed to the second stage is the permeate from the first stage. The CDBR invention described here achieves higher overall water recovery by processing both the permeate and retentate from the first RO stage. Moreover, the CDBR invention operates at considerably lower pressure.
U.S. Pat. No. 7,097,769 uses multi-stage RO separation for concurrent desalination and boron removal. Alkaline chemicals are added in the second RO stage to increase the Ph above 9. As such, the pH of the product water from this multi-stage process has to be adjusted downward back to near neutral pH. Moreover, since it employs conventional RO, it must operate at high pressure. The CDBR invention described here does not require the addition of any chemicals to adjust the pH and operates at a considerably reduced pressure.
U.S. Pat. No. 5,833,846 describes a high-purity water producing apparatus that reduces the boron concentration to less than 10 ppt. However, it is a complex process involving a double-pass RO stage unit and another stage that involves either electrodialysis or distillation individually or in combination. This process has a complex design that does not involve simultaneous desalination and boron removal. Moreover, the use of conventional RO necessarily requires operation at higher pressure. The CDBR invention described here involves a relatively simple process design that allows concurrent desalination and boron removal and enables operation at a substantially lower pressure.
U.S. Pat. No. 5,250,185 uses the addition of alkaline chemicals to raise the pH in order to increase the boron rejection in an RO membrane stage. The chemicals added to increase the pH must be removed in the product water from this process. Since this process employs conventional single stage RO, it necessarily operates at higher pressure. The CDBR invention does not require the addition of any chemicals and enables operation at substantially lower pressure.
U.S. Pat. No. 4,755,298 describes a cyclic continuous process for the removal of boron ion from aqueous streams via absorption and binding to a chelating agent. Polymers having pendant N-alkylglucamine or its derivatives serve as chelating agents to bind boron that subsequently can be released by treatment with a dilute aqueous mineral acid. Whereas this process can effectively reduce the boron concentration, it does not address concurrent desalination. In order to achieve desalination and boron removal, this process would have to be used in series with conventional RO or some other separations technology to reduce the salt concentration. The CDBR invention achieves desalination and boron removal concurrently.

No prior patents involve a process for concurrently effecting desalination and boron removal to achieve product water concentrations of less than 350 ppm of salt and 0.5 ppm of boron and that require only multistage membrane separations at a significantly reduced pressure while requiring no addition of chemicals to increase the pH.

This invention is a novel membrane technology referred to as the Concurrent Desalination Boron Removal (CDBR) process. The CDBR invention enables water desalination and boron removal to be done at the same time using membrane technology in order to achieve the desired concentrations in the product water. The SEC for conventional RO process technology is high because of the large osmotic pressure differential (OPD) between a concentrated salt solution and nearly pure water and because the water recovery is relatively low. This CDBR invention capitalizes on the recently invented energy-efficient reverse osmosis (EERO) process. The EERO process reduces the OPD and increases the water recovery by a judicious combination of single-stage reverse osmosis (SSRO) and a countercurrent membrane cascade with recycle (CMCR). However, the EERO process cannot reduce the typical boron concentration in seawater to an acceptable level in the product water.

### SUMMARY

The present invention uses membrane technology to concurrently desalinate a saline water feed and reduce the boron concentration to 0.5 ppm or lower at lower operating pressures, higher water recovery, and lower specific energy consumption. Prior art either involves desalination followed by boron removal or requires the addition of chemicals to increase the pH (logarithm of the hydrogen ion concentration) to enable adequate removal of the boron. Any chemicals added to increase the pH must be removed in the product water. Prior art that uses conventional reverse osmosis necessarily operates at higher pressures than this novel CDBR invention.

In fact; the present invention draws upon the features of the EERO process that enable it to reduce the OPD and increase the water recovery, but also makes a substantive addition to the process technology to permit concurrent removal of boron to an acceptable level using currently available commercial RO membranes. In one embodiment of this novel CDBR invention the retentate product from the high pressure side of an SSRO stage is introduced optimally at a point between two stages in a CMCR. The permeate from the SSRO stage is sent as the feed to a low pressure membrane stage (LPMS) to achieve further boron removal. The permeate product from the CMCR is blended with the permeate product from the LPMS to achieve the desired boron concentration in the potable water product. This novel process configuration achieves the desired boron concentration in a potable water product stream at a significantly reduced OPD, high water recovery, and competitive SEC. It accomplishes this by (i) introducing the retentate from the SSRO stage optimally as the feed to the CMCR; (ii) countercurrent retentate and permeate flow in the CMCR; (iii) permeate recycle to the retentate side in the CMCR; (iv) retentate self-recycling in at least one of the membrane stages in the CMCR; (v) introducing the permeate from the SSRO stage as the feed to an LPMS; and (vi) blending the permeate streams from the CMCR and LPMS to achieve the desired concentrations in the water product. Permeate recycle involves sending the permeate stream from a stage to the retentate (high pressure) side of the stage immediately downstream from it (i.e., in the direction of the permeate flow). Retentate self-recycling involves sending part of the retentate to the permeate side of the same stage; this can be done by using a nanofiltration (NF) membrane whose salt rejection is considerably lower than that of an RO membrane. The CDBR process configuration is energy-efficient because (i) the SSRO in combination with the CMCR reduces the OPD; (ii) the LPMS operates at very low pressure relative to an RO stage; and (iii) blending the permeate products from the LPMS and CMCR minimizes the amount of water that needs to pass through the LPMS to reduce the boron concentration.

### BRIEF DESCRIPTION OF THE DRAWINGS

FIG. 1. The schematic of the 4-stage embodiment of the CDBR invention whereby the high pressure retentate from stage 1, an RO stage, is the feed to a CMCR consisting of stage 2, an NF stage, and stage 3, an RO stage, and the permeate is the feed to stage 4, an LPMS. The CMCR employs permeate recycle from stage 2 to the high pressure side of stage 3 and retentate recycle from the high to the low pressure side of stage 2 via an NF membrane. The permeate streams from stage 3 and stage 4 are blended to achieve the desired salt and boron concentrations.

FIG. 2. (a) Osmotic pressure difference and (b) net specific energy consumption in the CDBR invention as a function of overall water recovery values ranging from 50% to 75%. These results are for a feed containing 35000 ppm of salt and 10 ppm of boron and a potable water product containing no more than 350 ppm of salt and 0.5 ppm of boron. Values are compared to those of the conventional SSRO for desalination that cannot reduce the boron concentration to 0.5 ppm.

FIG. 3a. The schematic of an alternative embodiment of the CDBR invention: CDBR-B, where the permeate stream out of Stage 1 is split in two fractions through a flow splitter, and one fraction is fed to the Stage 4, whereas the other fraction bypasses Stage 4 to be mixed with the permeate streams out of Stage 4 and Stage 3.

FIG. 3b. The schematic of an alternative embodiment of the CDBR-B invention: CDBR-BR, where the retentate from Stage 4 is totally or partially recycled as feed to Stage 1.

FIG. 4. The schematic of an alternative embodiment of CDBR invention with two SSRO stages wherein the salt water feed is introduced to the high pressure side of the first SSRO stage and the retentate of the first SSRO stage is introduced to the high pressure side of the second SSRO stage while the retentate of the second SSRO stage is introduced to the CMCR unit.

### DETAILED DESCRIPTION OF THE EMBODIMENTS

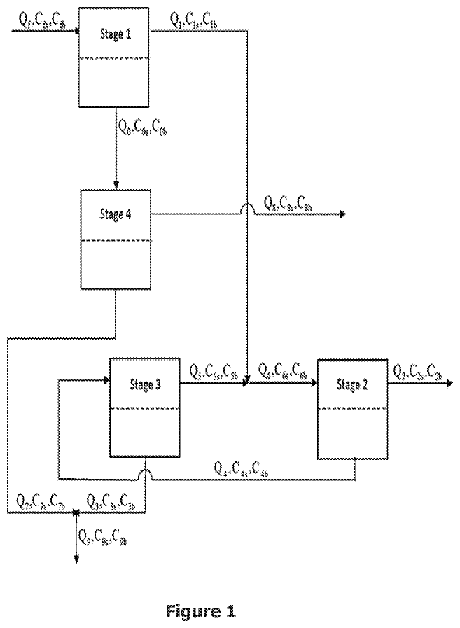

The present invention involves an SSRO stage (stage 1) whose retentate stream serves as the feed to a two-stage CMCR (stages 2 and 3) and whose permeate stream serves as the feed to an LPMS (stage 4). FIG. 1 is a schematic showing the 4-stage embodiment of this CDBR invention. The SSRO stage involves one or more reverse osmosis modules connected in parallel. In another embodiment of the CDBR invention, stage 1 could consist of two or more RO modules or parallel trains of RO modules connected in series. Each stage in the CMCR could involve one or more membrane modules connected in parallel. The direction of the retentate flow in the CMCR is referred to as the upstream direction (to the right in FIG. 1) and the direction of the permeate flow in the CMCR is referred to as the downstream direction (to the left in FIG. 1). In FIG. 1 the retentate (high pressure) stream from stage 1 is introduced between stages 2 and 3 in the CMCR. In another embodiment of the CDBR invention the CMCR could involve more than two stages in which case the retentate stream from stage 1 would be introduced optimally between two stages in the CMCR. The optimal point is that at which the concentration of the retentate stream from stage 1 that serves as the feed to the CMCR is closest to that of the retentate from the stage immediately downstream and the permeate recycle stream immediately upstream from the point at which the feed is introduced. In the 4-stage embodiment of this invention shown in FIG. 1, the CMCR operates at the same pressure as the retentate stream from stage 1 implying that no booster pump is required for the feed to the CMCR. When more than two stages are employed in the CMCR, all the stages can be operated at the same pressure implying that no interstage pumping is required on the high pressure side of the CMCR. Alternatively the pressure can be reduced between successive stages in the direction of the retentate flow in the CMCR in order to reduce the OPD at the expense of a reduced water recovery. The permeate stream from stage 1 is introduced as the feed to an LPMS (stage 4) in order to reduce its boron concentration. Stage 4 can be run at a pressure only slightly above the ambient pressure since there is very little difference in the salt concentration between the feed and permeate sides of the membrane in this stage. The boron concentration in the permeate from stage 4 will be well below 0.5 ppm. Hence, in order to achieve the desired boron concentration in the product stream, the permeate from stage 4 is blended with the permeate from stage 3 in the CMCR whose boron concentration usually is higher than 0.5 ppm for a typical saline water feed containing 10 ppm of boron.

The manner in which this CDBR invention reduces the SEC while reducing the OPD, increasing the water recovery, and achieving the desired salt and boron concentrations first will be explained in qualitative terms, after which the embodiment of this invention shown in FIG. 1 will be analyzed quantitatively. Note that the analysis done here is for operation of stage 1 and the CMCR stages at the thermodynamic limit. However, the thermodynamic limit is not relevant for stage 4 for which the required pressure differential is determined from the permeate volumetric flux and the permeability coefficient for the membrane in this stage. Design at the thermodynamic limit implies that the pressure is just equal to that required to overcome the OPD owing to the concentration difference between the high and low pressure sides of the membrane. No allowance is made for the small pressure losses in the lines leading to and from the membrane stages or within the membrane modules on the high pressure side or to cause permeation through the membranes. This is standard practice in determining the efficiency of a membrane process and will be used to assess the performance of this CDBR invention for concurrent desalination and boron removal as well as determining the performance of conventional SSRO for desalination in the absence of any boron removal, which is used as the basis for comparison.

This CDBR invention combines SSRO with a CMCR by sending the retentate stream from the SSRO as the feed to the CMCR. In FIG. 1 the retentate stream from stage 1 is introduced as the feed between stages 2 and 3 of the CMCR. By introducing the retentate from stage 1 as the feed to the CMCR, more water can be recovered, which contributes to decreasing the SEC. This can be done without any increase in the OPD in order to minimize the pumping costs that contribute to the SEC. Hence, one embodiment of this CDBR invention involves operating the CMCR at the same pressure as the retentate stream from stage 1 and not employing any interstage pumping on the high pressure (retentate) side of the CMCR. Since the retentate from the SSRO has a higher salt concentration than that of the saline water feed to the SSRO, operating the CMCR without any interstage pumping requires reducing the OPD in the CMCR. This is done by permeate recycle from stage 2 to the high pressure side of stage 3 in the CMCR while at the same time using a membrane in stage 2 that passes more salt than the highly rejecting membrane used in stage 3. The combination of recycle of the permeate from stage 2 to the high pressure side of stage 3 and some salt permeation from the high pressure side to the permeate side of the membrane in stage 2 reduces the concentration difference across the membranes in both stages 2 and 3, thereby permitting a high recovery of potable water without the need to increase the pressure beyond that of the retentate stream from stage 1. Another embodiment of this CDBR invention would allow for a pressure decrease or increase from the point at which the feed is introduced in the direction of the retentate flow, which is to the right in FIG. 1. In particular, decreasing or increasing the pressure can be used to decrease or increase the recovery in stage 2 to compensate for not being able to obtain an NF membrane with the optimal salt rejection. The boron concentration in the permeate from the CMCR usually will be higher than 0.5 ppm since the CMCR is processing the retentate from stage 1 whose boron concentration will be much higher than that of the saline water feed to this stage. Hence, in order to achieve the desired boron concentration, the permeate from stage 1, whose boron concentration is already significantly reduced from that of the feed to this stage, serves as the feed to stage 4, an LPMS. The latter employs a membrane with a boron rejection similar to that of the membrane in stage 1 and hence reduces the boron concentration to well below 0.5 ppm. The permeate from stage 4 is blended in the proper proportion with that from stage 3 in the CMCR in order to achieve the desired boron concentration in the blended product stream. This configuration in the CDBR concurrently achieves desalination and boron removal while minimizing the amount of water that is sent to stage 4.

In order to demonstrate quantitatively that this CDBR invention can achieve a boron removal down to 0.5 ppm concurrently with desalinating seawater to produce a potable water product having a salt concentration less than 350 ppm at a high water recovery, reduced OPD, and competitive SEC, the mathematical equations describing the interrelationship between the volumetric fluxes denoted by Qi in FIG. 1, and the salt and boron concentrations expressed as mass per unit volume and denoted by Cₛᵢ and C_{bi}, respectively, in FIG. 1, where the subscript ‘i’ denotes the location of the particular stream or concentration, will be solved analytically. The solution to this system of algebraic equations will permit determining the recovery, OPD, SEC, and initially unspecified salt and boron rejections in each stage of the CDBR and LPMS.

The analysis of this 4-stage CDBR invention involves solving overall material and solute balances for each of the four stages and at the two mixing points. The balances over stage 1 constitute 3 equations involving 9 unknowns (Q_{f}, C_{fs}, C_{fb}, Q₀, C₀ₛ, C_{0b}, Q₁, C₁ₛ, C_{1b}). The balances over stage 2 constitute 3 equations involving 9 unknowns (Q₂, C₂ₛ, C_{2b}, Q₄, C₄ₛ, C_{4b}, Q₆, C₆ₛ, C_{6b}). The balances over stage 3 constitute 3 equations involving 6 unknowns (Q₃, C₃ₛ, C_{3b}, Q₅, C₅ₛ, C_{5b}). The balances over stage 4 constitute 3 equations in 6 unknowns (Q₇, C₇ₛ, C_{7b}, Q₈, C₈ₛ, C_{8b}). The balances at the mixing point between stages 2 and 3 constitute 3 equations and 0 unknowns. The balances at the mixing point where the permeate streams from stages 3 and 4 are blended constitute 3 equations in 3 unknowns (Q₉, C₉ₛ, C9b). This totals 18 equations that involve 33 unknowns. This implies 15 degrees of freedom in solving the equations for this 4-stage CDBR process.

The 15 degrees of freedom were satisfied by specifying the following quantities shown in figure above:
1. Q_{f}, flow rate of saline water feed to stage 1
2. C_{fs}, salt concentration in the feed to stage 1
3. C_{fb}, boron concentration in the feed to stage 1
4. C_{9b}, boron concentration in blended permeate streams from stages 3 and 4
5. C₀ₛ=C₃ₛ required to have OPD in CMCR equal to OPD in stage 1
6. Δπ₁, OPD in stage 1
7. Δπ₂=Δπ₃, equal OPDs in stages 2 and 3 of the CMCR
8. Y₂, recovery in stage 2
9. Y₃, recovery in stage 3
10. Y₄, recovery in stage 4
11. σ₁ₛ, salt rejection in stage 1
12. σ_{1b}, boron rejection in stage 1 (scaled to salt rejection in stage 1)
13. σ_{2b}, boron rejection in stage 2 (scaled to salt rejection in stage 2)
14. σ_{3b}, boron rejection in stage 3 (scaled to salt rejection in stage 3)
15. σ₄ₛ, salt rejection in stage 4 (scaled to boron rejection in stage 4)

Specification of the 15 quantities is not unique. The values of other input parameters could be specified.

Overall and solute mass balances for stage 1 are given by the following:

Q_{f}=Q₀+Q₁ (1)

Q_{f}C_{fs}=Q₀C₀ₛ+QᵢC₁ₛ (2)

Q_{f}C_{fb}=Q₀C_{0b}+Q₁C_{1b} (3)

Overall and solute mass balances for stage 2 are given by the following:

Q₆=Q₂+Q₄ (4)

Q₆C₆ₛ=Q₂C₂ₛ+Q₄C₄ₛ (5)

Q₆C_{6b}=Q₂C_{2b}+Q₄C_{4b} (6)

Overall and solute mass balances for stage 3 are given by the following:

Q₄=Q₃+Q₅ (7)

Q₄C₄ₛ=Q₃C₃ₛ+Q₅C₅ₛ (8)

Q₄C_{4b}=Q₃C_{3b}+Q₅C_{5b} (9)

Overall and solute mass balances for stage 4 are given by the following:

Q₀=Q₇+Q₈ (10)

Q₀C₀ₛ=Q₇C₇ₛ+Q₈C₈ₛ (11)

Q₀C_{0b}=Q₇C_{7b}+Q8C_{8b} (12)

Overall and solute mass balances at the mixing point between stages 2 and 3 are given by the following:

Q₆=Q₁+Q₅ (13)

Q₆C₆ₛ=Q₁C₁ₛ+Q₅C₅ₛ (14)

Q₆C_{6b}=Q₁C_{1b}+Q₅C_{5b} (15)

Overall and solute mass balances at the mixing point where the permeate streams from stages 3 and 4 are blended are given by the following:

Q₉=Q₃+Q₇ (16)

Q₉C₉ₛ=Q₃C₃ₛ+Q₇C₇ₛ (17)

Q₉C_{9b}=Q₃C_{3b}+Q₇C_{7b} (18)

The additional equations that relate the volumetric fluxes and concentrations are given by the following:

Δπ₁=K(C₁ₛ−C₀ₛ) OPD is specified in stage 1 (19)

Δπ₂=Δπ₃⇒C₂ₛ−C₄ₛ=C₅ₛ−C₃ₛ OPDs set equal in CMCR (20)

$$\begin{matrix}{Y}_{2} = \frac{{Q}_{4}}{{Q}_{6}} & ( 21 ) \\ {Y}_{3} = \frac{{Q}_{3}}{{Q}_{4}} & ( 22 ) \\ {Y}_{4} = \frac{{Q}_{7}}{{Q}_{0}} & ( 23 ) \\ {σ}_{1 s} = \frac{{C}_{fs} - {C}_{0 s}}{{C}_{fs}} & ( 24 ) \\ {σ}_{1 b} = \frac{{C}_{fb} - {C}_{0 b}}{{C}_{fb}} = \frac{0.90}{0.97} {σ}_{1 s} & ( 25 ) \\ {σ}_{2 b} = \frac{{C}_{6 b} - {C}_{4 b}}{{C}_{6 b}} = \frac{{σ}_{1 b}}{{σ}_{1 s}} {σ}_{2 s} & ( 26 ) \\ {σ}_{3 b} = \frac{{C}_{4 b} - {C}_{3 b}}{{C}_{4 b}} = \frac{{σ}_{1 b}}{{σ}_{1 s}} {σ}_{3 s} & ( 27 ) \\ {σ}_{4 s} = \frac{{C}_{0 s} - {C}_{7 s}}{{C}_{0 s}} = \frac{{σ}_{1 s}}{{σ}_{1 b}} {σ}_{4 b} & ( 28 )\end{matrix}$$

Solving these equations gives the following for the volumetric fluxes:

$$\begin{matrix}{Q}_{0} = \frac{{Q}_{f} ( {C}_{1 s} - {C}_{fs} )}{{C}_{1 s} - {C}_{0 s}} & ( 29 ) \\ {Q}_{1} = \frac{{Q}_{f} ( {C}_{fs} - {C}_{0 s} )}{{C}_{1 s} - {C}_{0 s}} & ( 30 ) \\ {Q}_{2} = {Q}_{6} - {Q}_{4} & ( 31 ) \\ {Q}_{3} = {Y}_{2} {Y}_{3} {Q}_{6} & ( 32 ) \\ {Q}_{4} = {Y}_{2} {Q}_{6} & ( 33 ) \\ {Q}_{5} = ( 1 - {Y}_{3} ) {Y}_{2} {Q}_{6} & ( 34 ) \\ {Q}_{6} = \frac{{Q}_{1}}{1 - ( 1 - {Y}_{3} ) {Y}_{2}} & ( 35 ) \\ {Q}_{7} = {Y}_{4} {Q}_{0} & ( 36 ) \\ {Q}_{8} = {Q}_{0} - {Q}_{7} & ( 37 ) \\ {Q}_{9} = {Q}_{3} + {Q}_{7} & ( 38 )\end{matrix}$$

Solving for the salt concentrations gives the following:

$$\begin{matrix}{C}_{0 s} = ( 1 - {σ}_{1 s} ) {C}_{fs} & ( 39 ) \\ {C}_{1 s} = \frac{{Δπ}_{1}}{K} + {C}_{0 s} & ( 40 ) \\ {C}_{2 s} = \frac{{Q}_{1} {C}_{1 s} - {Q}_{3} {C}_{3 s}}{{Q}_{2}} & ( 41 ) \\ {C}_{3 s} = {C}_{0 s} & ( 42 ) \\ {C}_{4 s} = \frac{{Q}_{1} {C}_{1 s} + {Q}_{5} {C}_{5 s} - {Q}_{2} {C}_{2 s}}{{Q}_{4}} & ( 43 ) \\ {C}_{5 s} = \frac{( {Q}_{4} - {Q}_{2} ) {Q}_{1} {C}_{1 s} + {Q}_{2}^{2} {C}_{2 s} + ( {Q}_{2} - {Q}_{3} ) {Q}_{4} {C}_{3 s}}{{Q}_{2} ( {Q}_{4} + {Q}_{5} )} & ( 44 ) \\ {C}_{6 s} = \frac{{Q}_{1} {C}_{1 s} + {Q}_{5} {C}_{5 s}}{{Q}_{6}} & ( 45 ) \\ {C}_{7 s} = ( 1 - {σ}_{4 s} ) {C}_{0 s} & ( 46 ) \\ {C}_{8 s} = \frac{{Q}_{0} {C}_{0 s} - {Q}_{7} {C}_{7 s}}{{Q}_{8}} & ( 47 ) \\ {C}_{9 s} = \frac{{Q}_{3} {C}_{3 s} + {Q}_{7} {C}_{7 s}}{{Q}_{9}} & ( 48 )\end{matrix}$$

Solving for the boron concentrations gives the following:

$$\begin{matrix}{C}_{0 b} = ( 1 - {σ}_{1 b} ) {C}_{fb} & ( 49 ) \\ {C}_{1 b} = \frac{{Q}_{f} {C}_{fb} - {Q}_{0} {C}_{0 b}}{{Q}_{1}} & ( 50 ) \\ {C}_{2 b} = \frac{{Q}_{1} {C}_{1 b} - {Q}_{3} {C}_{3 b}}{{Q}_{2}} & ( 51 ) \\ {C}_{3 b} = \frac{( 1 - {σ}_{3 b} ) ( 1 - {σ}_{2 b} ) {Q}_{1} {C}_{1 b}}{{Q}_{6} - ( 1 - {σ}_{3 b} ) ( 1 - {σ}_{2 b} ) ( \frac{{Q}_{4}}{1 - {σ}_{3 b}} - {Q}_{3} )} & ( 52 ) \\ {C}_{4 b} = ( 1 - {σ}_{2 b} ) {C}_{6 b} & ( 53 ) \\ {C}_{5 b} = \frac{{Q}_{4} {C}_{4 b} - {Q}_{3} {C}_{3 b}}{{Q}_{5}} & ( 54 ) \\ {C}_{6 b} = \frac{{Q}_{1} {C}_{1 b} + ( \frac{{Q}_{4}}{1 - {σ}_{3 b}} - {Q}_{3} ) {C}_{3 b}}{{Q}_{6}} & ( 55 ) \\ {C}_{7 b} = \frac{{Q}_{9} {C}_{9 b} - {Q}_{3} {C}_{3 b}}{{Q}_{7}} & ( 56 ) \\ {C}_{8 b} = \frac{{Q}_{0} {C}_{0 b} - {Q}_{7} {C}_{7 b}}{{Q}_{8}} & ( 57 )\end{matrix}$$

The pressure required in stage 4 is given by the following:

$$Δ {P}_{4} = \frac{{Q}_{0}}{{P}_{4}} \qquad ( 58 )$$

where P₄ is the permeability coefficient of the membrane in stage 4. The overall water recovery from this 4-stage CDBR process is given by the following:

Y=Q₉ (59)

The net specific energy consumption (SECₙₑₜ), which is the energy required per unit of water produced allowing for the recovery of the pressure energy in the retentate via an energy-recovery device (ERD), is given by the following:

$${SEC}_{net} = \frac{{Q}_{f} {Δπ}_{1} + {Q}_{4} {Δπ}_{3} + {Q}_{0} {Δπ}_{4}}{{η}_{p} {Q}_{9}} - \frac{{η}_{ERD} {Q}_{2} {Δπ}_{1}}{{Q}_{9}} \qquad ( 60 )$$

where p is the efficiency of the pumps and ERD is the efficiency of the ERD.

The predictions of Equations (29)-(60) will be used to establish the proof-of-concept for this CDBR invention. The performance of the CDBR invention will be assessed in terms of the OPD and SECₙₑₜ required to produce a potable water product containing 0.5 ppm of boron and no more than 350 ppm of salt from a saline water feed containing 35000 ppm of salt and 10 ppm of boron. The fractional water recovery values for stages 2 and 3 are input parameters in solving the model equations, which were chosen to be 0.3 and 0.7, respectively.

Running stage 2 at a lower recovery increases the safety factor (ratio of retentate to permeate flow) in this stage, thereby helping to mitigate concentration polarization and fouling in this stage that has a feed containing a high concentration of divalent salts. Running stage 3 at a higher recovery is possible since the feed to this stage has passed through both stage 1 and stage 2, thereby removing all the divalent salts that could cause scaling. The feed to stage 4 is nearly pure water since it has passed through stage 1, an RO stage; hence, the OPD in stage 4 is negligible. Moreover, the foulants have been removed in the feed to stage 4. Hence, stage 4 can be run at a very high water recovery or equivalently a very low safety factor. The only requirement is that there be sufficient retentate flow to remove the small amount of boron rejected by the membrane in stage 4. Hence, stage 4 is assumed to have a water recovery of 95%. Pump and ERD efficiencies of 85% and 90%, respectively, are assumed, which are consistent with commercially available devices. The performance of the CDBR invention will be assessed in terms of the OPD and SECₙₑₜ required to achieve the specified boron and salt concentrations in the product water for a range of overall water recoveries. The implications on the CDBR invention of using membranes having a range of salt rejections and a range of boron rejections also will be assessed. Whereas the salt and boron rejections are specified input parameters for stage 1, the salt rejections are predicted quantities in stages 2 and 3, and the boron rejection is a predicted quantity in stage 4. For stages 2 and 3 the boron rejection is scaled to the predicted salt rejection, whereas in stage 4 the salt rejection is scaled to the predicted boron rejection; that is, the ratio of the boron rejection to the salt rejection is assumed to be the same as that attainable via currently available commercial membranes that can achieve rejections of 90.0% and 99.7% for boron and salt, respectively.

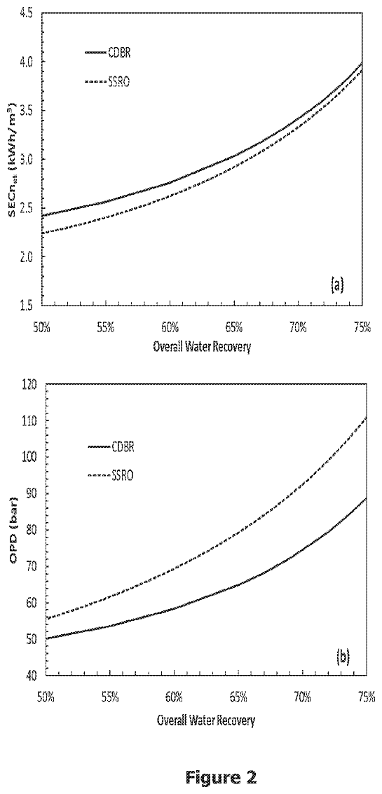

The OPD is a specified input parameter used in solving Equations (1) to (28) for the volumetric fluxes and concentrations in the CDBR invention. The overall water recovery is determined from Equation (59) using the volumetric fluxes determined from Equations (29) to (38). FIG. 2 shows a plot of the OPD and SECₙₑₜ as a function of overall water recovery ranging from 50% to 75%; these predictions are for achieving a product water with a salt concentration equal to or less than 350 ppm and a boron concentration of 0.5 ppm, both of which meet WHO recommendations for potable and irrigation water. The salt and boron rejections of the membranes for stages 1 to 4 and the recovery at stage 2 are summarized in Table 1. FIG. 2 also shows the OPD and SECₙₑₜ for SSRO which cannot achieve 0.5 ppm of product water boron concentration.

TABLE 1
Required salt and boron rejections and recovery in stage 2 in the CDBR
invention for both desalination and boron removal producing a water
product with a salt concentration equal to 350 ppm and a boron
concentration of 0.5 ppm.

| Recovery | σ₁ₛ | σ₂ₛ | σ₃ₛ | σ₄ₛ | σ_{1b} | σ_{2b} | σ_{3b} | σ_{4b} | Y2 |
|---|---|---|---|---|---|---|---|---|---|
| 50% | 0.997 | 0.833 | 0.990 | 0.545 | 0.900 | 0.752 | 0.894 | 0.492 | 0.165 |
| 65% | 0.997 | 0.660 | 0.996 | 0.645 | 0.900 | 0.596 | 0.899 | 0.582 | 0.339 |
| 75% | 0.996 | 0.543 | 0.997 | 0.731 | 0.899 | 0.490 | 0.900 | 0.660 | 0.456 |

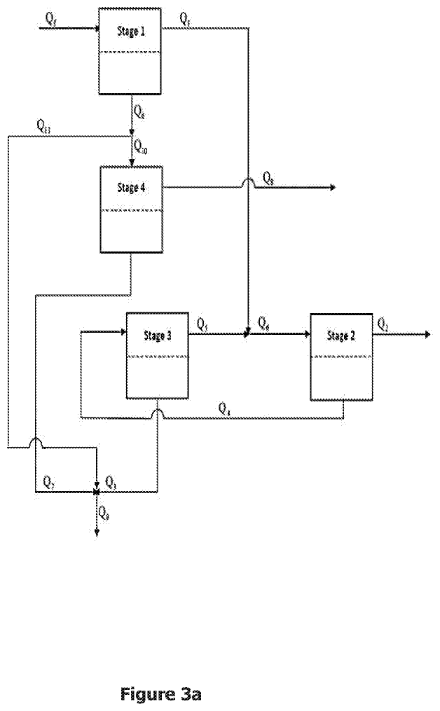

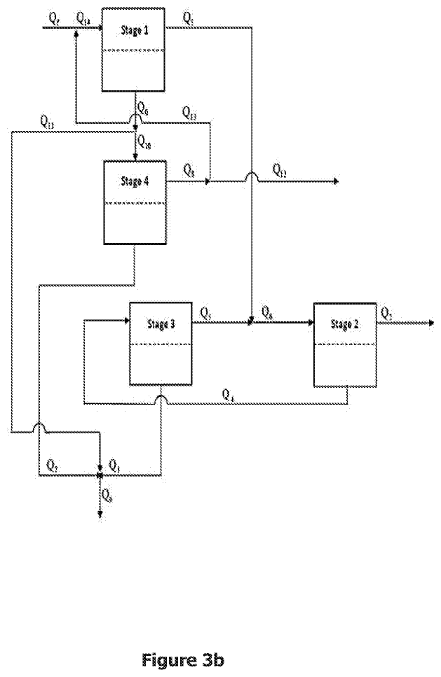

It is of interest to determine the minimum value of the boron rejection required for the CDBR invention to produce product water that contains no more than 350 ppm of salt and a specified boron concentration of 0.5 ppm and to determine the implications for the CDBR invention if membranes with boron rejections higher than 90% could be obtained. FIG. 3 shows a plot of the boron rejection of the membrane in stage 4 as a function of the specified boron rejection of the membrane in Stage 1 required to achieve a product water containing no more than 350 ppm of salt and a specified boron concentration of 0.5 ppm for overall water recovery values of 50%, 65%, and 75%. Table 2 indicates that the specified water product concentrations can be achieved even with a membrane having a boron rejection as low as 0.804, 0.834, and 0.851 for an overall water recovery values of 50%, 65%, and 75%, respectively. These boron rejections are well below the 0.90 boron rejection attainable via currently available commercial RO membranes.

TABLE 2
Minimum boron rejections in the CDBR invention for overall water
recovery values of 50%, 65%, and 75% required to produce a
water product having a salt concentration equal to or less than
350 ppm and a specified boron concentration of 0.5 ppm.

| Recovery | σ_{1b} | σ_{2b} | σ_{3b} | σ_{4b} |
|---|---|---|---|---|
| 50% | 0.804 | 0.672 | 0.798 | 0.803 |
| 65% | 0.834 | 0.552 | 0.833 | 0.833 |
| 75% | 0.850 | 0.464 | 0.851 | 0.851 |

Table 3 compares the OPD and SECₙₑₜ for conventional SSRO for just desalination and the novel CDBR invention for achieving a water product having a salt concentration of 350 ppm and a boron concentration of 0.5 ppm for overall water recoveries of 50%, 65% and 75%. Note that conventional SSRO cannot reduce the boron concentration to 0.5 ppm for a typical saline water feed containing 10 ppm of boron using commercially available RO membranes. The CDBR invention can achieve the same overall water recovery as conventional SSRO at a substantially reduced OPD. The CDBR invention reduces the OPD required for just desalination via SSRO by 10%, 18%, and 20% at overall water recovery values of 50%, 65%, and 75%, respectively. The CDBR invention results in an increase in the SECₙₑₜ of 8%, 4%, and 2% for overall water recovery values of 50%, 65%, and 75%, respectively, relative to using conventional SSRO for just desalination. Since the CDBR invention can desalinate and reduce the boron concentration to 0.5 ppm at a substantially reduced OPD, it will translate to a significant reduction in the fixed costs for the pumps, piping, and pressure vessels relative to using SSRO for just desalination. Moreover, operation at lower pressure via the CDBR invention will reduce the maintenance costs for desalination and boron removal.

TABLE 3
Comparison of the OPD and SECₙₑₜ for desalination using SSRO and
the CDBR invention for both desalination and boron removal
producing a water product with a salt concentration equal to or less
than 350 ppm and a boron concentration of 0.5 ppm.

| | 50% Recovery | | 65% Recovery | | 75% Recovery | |
|---|---|---|---|---|---|---|
| | OPD | SECₙₑₜ | OPD | SECₙₑₜ | OPD | SECₙₑₜ |
| Process | (bar) | (kWh/m³) | (bar) | (kWh/m³) | (bar) | (kWh/m³) |
| SSRO | 55.5 | 2.242 | 79.3 | 2.922 | 111 | 3.915 |
| CDBR | 50.2 | 2.420 | 64.9 | 3.033 | 88.9 | 3.990 |

The proof-of-concept for the CDBR invention has been shown in detail for the four-stage embodiment involving sending the retentate from an SSRO stage to a 2-stage CMCR and sending the permeate from the SSRO stage to an LPMS after which the permeate streams from the CMCR and LPMS are blended to achieve the desired salt and boron concentrations. The CDBR invention has been shown to capable of producing a water product having a salt concentration equal to or less than 350 ppm and a specified boron concentration of 0.5 ppm, which meets WHO recommendations for potable and irrigation water. The CDBR invention has been shown to achieve the specified water product concentrations at substantially lower pressures than required for just desalination via conventional SSRO for the same overall water recovery. Moreover, the CDBR invention can achieve the specified water product concentrations at a SECₙₑₜ only slightly higher than for just desalination via conventional SSRO at moderate recoveries of 50% and at nearly the same values as conventional SSRO for recoveries of 65% and 75%. Since the CDBR invention substantially reduces the pressure required for desalination and concurrent boron removal, it will reduce the fixed costs of construction associated with the pumps, piping, and pressure vessels and will reduce the maintenance costs associated with continuous operation at high pressure. These additional cost reductions are not included in the proof-of-concept analysis.

The proof-of-concept for this CDBR invention has been shown based on maintaining the same OPD in stages 1, 2, and 3. This embodiment of the EERO invention is advantageous since it avoids any interstage pumping on the high pressure side of the CMCR. However, another embodiment of this CDBR invention is to allow for a reduced OPD in one or more of the stages in the CMCR while at the same time avoiding any interstage pumping on the high pressure side of the CMCR membrane cascade. This will reduce the pumping costs at the expense of a reduced potable water recovery. For some applications this embodiment of the CDBR invention could be desirable. The CDBR invention may be also implemented in two additional embodiments that are illustrated in FIG. 3:
a) The permeate stream out of Stage 1 may be split in two fractions through a flow splitter, where one fraction is fed to the Stage 4 as in the case of the original invention, whereas the other fraction bypasses Stage 4 to be mixed with the permeate streams out of Stage 4 and Stage 3. This embodiment is called CDBR-B and introduces a new input parameter, the split ratio (S) which is defined as the ratio of the flowrate of the stream bypassing Stage 4 to the flow rate of the permeate stream out of Stage 1. When S=0, the original CDBR invention is recovered. Having a flow splitter that affects the concentrations in the final product could be also an advantage since it provides a simple way to compensate for any changes in the system elsewhere such as changes in the permeability due to fouling or concentration polarization, membrane aging, etc.
b) The retentate from Stage 4 may be totally or partially recycled as feed to Stage 1. This embodiment is called CDBR-BR. Since the salt concentration of the retentate from Stage 4 is less than that of the seawater feed to Stage 1, which it might well be, it will dilute the feed and thereby should lower the required OPD in Stages 1, 2, and 3. Increasing the feed flow to Stage 1 by recycling the retentate from Stage 4 would also increase the safety factor (i.e., ratio of retentate flow rate to permeate flow rate) and permit running Stage 1 at a higher recovery.

The process conditions for the CDBR-B invention to produce a product water that contains no more than 350 ppm of salt and a specified boron concentration of 0.5 ppm are summarized in Table 4. It yields the OPD and SECₙₑₜ lower than SSRO at all recoveries.

TABLE 4
Comparison of the OPD and SECₙₑₜ for desalination using SSRO and the
CDBR-B invention for both desalination and boron removal producing a
water product with a salt concentration equal to or less than 350 ppm and
a boron concentration of 0.5 ppm.

| | | | | | | | OPD | SECₙₑₜ |
|---|---|---|---|---|---|---|---|---|
| Recovery | Y2 | S | σ₁ₛ | σ₄ₛ | σ_{1b} | σ_{4b} | (bar) | (kWh/m³) |
| 75% | 0.392 | 0.30 | 0.996 | 0.997 | 0.899 | 0.900 | 88.7 | 3.81 |
| 65% | 0.295 | 0.37 | 0.997 | 0.997 | 0.900 | 0.900 | 65.0 | 2.92 |
| 50% | 0.150 | 0.44 | 0.997 | 0.997 | 0.900 | 0.900 | 49.8 | 2.35 |

It is also of interest to determine the performance of the proposed invention for desalination only. It would be possible to obtain a water product with 0.350 ppm salt concentration at lower OPD and SECₙₑₜ values than SSRO when the CDBR-BR invention is used. In Table 5, the performance of the CDBR-BR invention with a split ratio of 0.95 and a complete recycle of the retentate from Stage 4 is compared to that of SSRO for desalination for 65% and 75% water recoveries.

TABLE 5
Comparison of the OPD and SECₙₑₜ for desalination
using SSRO and the CDBR-BR invention producing a water
product with a salt concentration equal to 350 ppm.

| | 65% Recovery | | 75% Recovery | |
|---|---|---|---|---|
| | OPD | SECₙₑₜ | OPD | SECₙₑₜ |
| Process | (bar) | (kWh/m³) | (bar) | (kWh/m³) |
| SSRO | 79.3 | 2.922 | 111 | 3.915 |
| CDBR-BR | 61.0 | 2.718 | 79.3 | 3.387 |

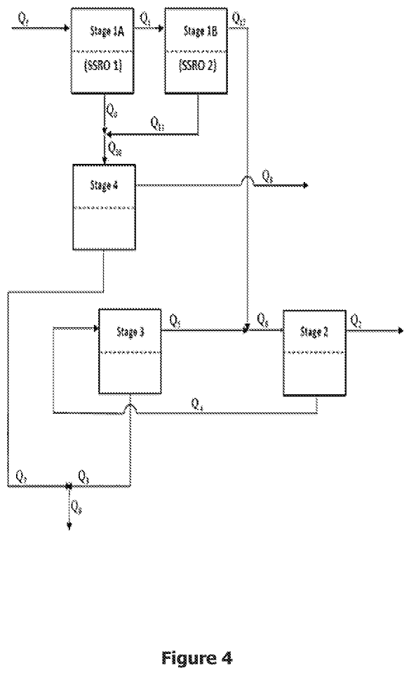

Furthermore, instead of the SSRO stage in the embodiments described in FIGS. 1, 3a and 3b, two or more SSRO stages can be used, wherein the salt water feed is introduced to the high pressure side of the first SSRO stage and the retentate of each SSRO stage is introduced to the high pressure side of the subsequent SSRO stage while the retentate of the last SSRO stage is introduced to the CMCR unit. The permeate of all SSRO stages are introduced to LMPS. In this embodiment, the OPD may be increased gradually between the first and last SSRO stages, and last SSRO stage operates at the same OPD as the CMCR unit, which results in a lower SECₙₑₜ compared to the original embodiment. As an example, in an embodiment of the CDBR invention with two SSRO stages, described in FIG. 4; for 75% water recovery, the first SSRO stage can operate at an OPD of 52.8 bar while the second SSRO stage and the rest of the CDBR unit operate at an OPD of 100 bar, resulting in a SECₙₑₜ of 3.117 kWh/m³, whereas for 65% water recovery, the first SSRO stage can operate at an OPD of 43.1 bar while the second SSRO stage and the rest of the CDBR unit operate at an OPD of 66.8 bar, resulting in a SECₙₑₜ of 2.606 kWh/m³ for producing a water product with a salt concentration equal to or less than 350 ppm and a boron concentration of 0.5 ppm.

What is claimed is:

1. A system for concurrent desalination and boron removal (CDBR) process, comprising:
a plurality of single-stage reverse osmosis (SSRO) stages connected in series, wherein each SSRO stage comprises one or more reverse osmosis (RO) modules connected in series; and
a countercurrent membrane cascade with recycle (CMCR), wherein the CMCR comprises at least two stages including a low pressure membrane stage (LPMS), wherein a retentate from the SSRO stage is fed to the CMCR and a permeate from the SSRO stage is fed to the LPMS;
permeate streams from the CMCR and LPMS are blended to achieve a predetermined boron concentration and/or a predetermined salt concentrations in a water product.

2. The system according to claim 1, wherein each stage in the SSRO, CMCR, and LPMS consists of one or more membrane modules connected in parallel.

3. The system according to claim 1, wherein the predetermined salt concentration is equal to or less than 350 ppm.

4. The system according to claim 1, wherein the predetermined boron concentration is equal to or less than 0.5 ppm.

5. The system according to claim 1, wherein the SSRO stage and the CMCR operate at a same osmotic pressure differential (OPD), neglecting small losses owing to a pressure drop required for a flow through lines and membrane modules or to cause permeation in the membrane modules.

6. The system according to claim 1, wherein the system supplies a boron removal at a higher water recovery at a lower osmotic pressure differential (OPD) and at a reduced specific energy consumption (SEC) relative to a conventional SSRO for saline water or an aqueous feed containing relatively low molecular weight solutes.

7. The system according to claim 1, wherein the system supplies a salt removal at a higher water recovery at a lower osmotic pressure differential (OPD) and at a reduced specific energy consumption (SEC), relative to a conventional SSRO for saline water or an aqueous feed containing relatively low molecular weight solutes.

8. The system according to claim 1, comprising one or more stages of the CMCR, wherein an osmotic pressure differential (OPD) is reduced in the one or more stages of the CMCR relative to an OPD in the SSRO stage.

9. system according to claim 1, comprising one or more stages of the CMCR, wherein an osmotic pressure differential (OPD) is increased in the one or more stages of the CMCR relative to an OPD in the SSRO stage.

10. A concurrent desalination and boron removal (CDBR) process for a production of potable and irrigation water, by comprising the below steps:
introducing a retentate from one SSRO stage or a series of SSRO stages optimally as a feed to a CMCR;
countercurrent a retentate flow and a permeate flow in the CMCR;
permeate recycling to a retentate side in the CMCR;
retentate self-recycling in at least one of membrane stages in the CMCR;
introducing a permeate from the SSRO stage(s) as a feed to an LPMS; and
blending permeate streams from the CMCR and LPMS to achieve concentrations in a water product.

11. The process according to claim 10, wherein the retentate from the SSRO stage is the feed to a stage in the CMCR, where a concentration of the CMCR is closest to concentrations of streams entering this stage.

12. The process according to claim 10, wherein a salt rejection of the membrane stages in the CMCR decreases in a direction of a retentate product to permit a permeation of a salt or other low molecular weight solutes from a high pressure side of membranes to a low pressure side of membranes in order to reduce an osmotic pressure differential (OPD).

13. The process according to claim 10, wherein an effective rejection in each stage of the CMCR is achieved by decreasing or increasing a pressure of the each stage.

14. The process according to claim 10, wherein a portion of the retentate from one or more stages is recycled back to a feed to a same stage in order to increase a recovery.

15. The process according to claim 10, wherein a safety factor in a stage is a ratio of the retentate to permeate flow in the stage, the ratio is less than one owing to a removal of sparingly soluble fouling agents in one or more stages preceding the stage in a direction of the retentate flow.

16. The process according to claim 10, wherein a water recovery in the LPMS is optimized to lower a specific energy consumption.

17. The process according to claim 10, wherein a boron concentration and/or a salt concentrations are reduced in seawater or brackish water to produce the potable and/or irrigation water using RO and NF membranes and high flux membranes.

18. A method of production of potable water or irrigation water, comprising:
using the system of claim 1 to produce the potable water or the irrigation water.

19. (canceled)
